(19) United States
(12) Patent Application Publication
(10) Pub. No.: US 2013/0150509 A1
(43) Pub. Date: Jun. 13, 2013

(54) Coil-Coated Spectrally Selective Coatings on Copper or Aluminum With Pigments Modified by Aminsilane

(71) Applicants: Alanod Aluminium-Veredlung GmbH & Co. KG, Ennepetal (DE); Helios, Tovarna Barv, Lakov In Umetnih, Domzale (SL)

(72) Inventors: Matjaz Kozelj, Krka (SL); Boris Orel, Ljublijana (SL); Miha Steinbuecher, Kamnik (SL); Ivan Jerman, Vransko (SL); Marjanca Vodlan, Medvode (SL); Dimitrios Peros, Siegen (DE)

(73) Assignees: Helios, Tovarna Barv, Lakov In Umetnih, Domzale (SL); Alanod Aluminium-Veredlung GmbH & Co. KG, Ennepetal (DE)

(21) Appl. No.: 13/758,298

(22) Filed: Feb. 4, 2013

Related U.S. Application Data
(62) Division of application No. 13/321,901, filed on Jan. 11, 2012.

(30) Foreign Application Priority Data
May 22, 2009 (SI) P-200900147

(51) Int. Cl. C08K 5/544

(52) U.S. Cl. CPC C08K 5/544
USPC 524/188

(57) ABSTRACT

In a method of manufacturing TSSS and TISS coatings applied onto substrates of copper or aluminum, inorganic pigments are functionalized by aminosilane. The functionalized pibment are used for making paints, which after the coil-coating onto the substrate form the coatings. For the functionalization, the pigment is dispersed in a solution of an aminosilane in a solvent or a mixture of a solvent and a binder without an addition of a non-aminosilane dispersing agent with or without subsequent grinding and use of 0.05-30% of aminosilane on pigment. An aromatic, aliphatic, cycloaliphatic, ketone, ester, ether or alcohol compound or a mixture thereof can be used as the solvent. A silicone-polyester, polyurethane or fluoropolymer can be used as the binder.

### CROSS-REFERENCE TO RELATED APPLICATIONS

This application is a divisional application of U.S. application Ser. No. 13/321,901 entitled “COIL-COATED SPECTRALLY SELECTIVE COATINGS ON COPPER OR ALUMINUM WITH PIGMENTS MODIFIED BY AMINOSILANE” filed on Nov. 22, 2011, which claims priority to Slovenian Application No. P-200900147, filed May 22, 2009 and PCT/EP2010/057032, filed May 21, 2010.

### FIELD OF THE INVENTION

This invention relates to aminosilane modified pigments, method of their preparation, coatings made with such pigments, their production and application. More specifically, this invention relates to a procedure of using aminosilanes for the treatment of various black and colored pigments with a view to modifying the pigments' surface properties, methods for obtaining the ensuing dispersions and making from them paints and coatings that show enhanced covering efficiency. The invention enabling the preparation of black or coloured Thickness Sensitive Spectrally Selective (“TSSS”), and Thickness Insensitive Spectrally Selective (“TISS”), and paint coatings, together with the method of their preparation and their use on metal and non-metal substrates.

### BACKGROUND OF THE INVENTION

Pigments treated with various amino functionalized silanes enable the preparation of pigment binder dispersions with essentially improved properties, reflected in smaller particles, their more uniform distribution in organic vehicles, and also providing the compatibility of the pigments' particles with the polymer resin binder matrix, thus enabling the preparation of stable paint systems with enhanced pigment loading and higher hiding properties.

This invention is primarily suitable for obtaining paint coatings for solar absorbers, glazed and unglazed, metallic or non-metallic but it is in no way limited to them.

The optical properties of any coatings are characterized by their transmittance, T (or t), absorbance, A (or a), and reflectance, R (or r), values, where T+A+R=1, which characteristics can attain various values in different parts of the electromagnetic spectrum. Typical examples of frequency dependent T (λ), R (λ) and A (λ) in the visible part of the solar spectrum, (VIS) having a wavelength at 0.3-0.6 μm, are ordinary paints with various colors, the reflectance of which should only be controlled in this spectral region. Solar cool paints and near infrared camouflage coatings for military applications require careful tuning of the optical properties also in the Near IR, (NIR) having a wavelength at 0.6-2.5 μm, while for the spectrally selective coatings for solar absorbers and thermovision camouflage coatings for military applications, the corresponding T (λ), R (λ) and A (λ) values must be adjusted over the entire spectral region from a wavelength of 0.3 to at least 50 μm, broad band spectral selectivity. In order to make coatings for the above mentioned applications, it is essential to know the optical properties of the pigments and resin binders for each of the spectral regions.

Solar collector paints and corresponding coatings require pigments that exhibit high solar absorbance, a_{S}˜0.94-0.95, values in the VIS and NIR solar regions. This is relatively easy to achieve by using black pigments, carbon soot (black), etc, since they show inherently high absorption in the entire solar spectrum. However, when such coatings are exposed to solar radiation and their temperature increases above the ambient temperature, up to 200° C. at stagnation conditions and up to 80° C. at operating temperatures for domestic solar heat water systems, the absorber surface starts to emit a large portion of its collected thermal energy in the form of thermal infrared radiation, λ>2.5 μm. In order to decrease these thermal radiation losses, the thermal emittance of the solar absorber must be reduced as much as possible, e_{T}<0.10 or less.

Accordingly, the main characteristic of spectrally selective coatings for solar absorbers is the difference between their solar absorbance, a_{S}, and thermal emittance, e_{T}. While high solar absorbance, a_{S}˜0.94-0.95, values are relatively easy to achieve, more effort needs to be devoted to achieve low emittance of coatings.

So far, various strategies exist and have been developed to make black highly solar absorbing coatings that also exhibit low thermal emittance. The chemical vapour deposition technique, (“CVD”), has proved to be the most effective deposition technique on metal, providing solar absorbers with a_{S}˜0.93-0.95 and e_{T}<0.08-0.05, depending on the metal used as a substrate. In principle, any black coating showing high a_{S} values could be low emitting when it is deposited on a metallic substrate with low thermal emittance like copper, stainless steel, aluminum, zinc coated steel, etc. and its physical thickness is comparable or lower to the wavelength of the thermal radiation. This leads to Thickness Sensitive Spectrally Selective, TSSS, paint coatings.

Thin TSSS paint coatings made of black pigment embedded in polymeric resin binder fail in both aspects. The pigment loadings expressed by the pigment to volume ratio (“PVC”) in paints are not as high as in TSSS coatings made by CVD processing, because the absorbing pigment particles do not form a percolated film. Inevitably, a_{S} values drop below the values characteristic for the bulk pigment, usually well below 0.90. On the other hand, thermal emittance of even very thin TSSS paint coatings is inherently high, due to the absorption of the polymeric binder stemming from the vibrational modes of the polymer itself. The use of polymeric binder in paint coatings cannot be avoided, because it imparts to the coatings the necessary mechanical strength and other application properties. The problem of how to avoid a reduction of a_{S} and an increase of e_{T} values of thin TSSS paint coatings is reduced by making paints that enable the provision of a coating consisting of pigment particles arranged in a single layer, in which the pigment particles are laterally linked one to another with the smallest possible amount of polymer binder, probably in the form of a monomolecular layer. Such coatings would have the smallest thickness, equal to the diameter of the elementary particle size of pigment, and consist of closely packed pigment particles bonded together by an organic polymer binder. This can only be achieved with paints made of dispersions with uniformly and finely dispersed pigment particles.

The preparation of such pigment dispersions, with non-agglomerated and finely distributed uniform particles, is not easy and requires careful selection of dispersants capable of providing appropriate interactions with the pigment particle surface and, on the other hand, adequate compatibility with the polymer binder systems.

Organic dispersants are normally used for the production of commercial paints. The preparation of the pigment dispersion starts with the addition of the dispersant to the binder solution before the milling process of the pigment is commenced. This procedure is also common to all procedures related to the preparation of TSSS coatings, as described in Z. Crnjak Orel, N. Leskov\check{s}ek, B. Orel, M. G. Hutchins, “Spectrally selective silicon paint coatings: Influence of pigment volume concentration ratio on their optical properties”. Sol. Energy mater. sol. cells., 1996, vol. 40, 197-204. A TSSS paint coating prepared with black spinel type pigment and silicone resin binder is described, demonstrating that the latter pigment provides coatings which have an essentially lower e_{T} than coatings made with carbon black pigment. In the same publication, it is also shown that it is desirable to prepare paints with the highest possible PVC ratios, thus leading to maximized a_{S} and minimal e_{T} values, whereby the limiting factors are the adhesion and temperature stability of the coatings. Optimal PVC ratios are between 16 and 20%, as stated by the authors, while the thickness of the applied coatings has been expressed with the weight in g of dry coating per unit of area in m², e.g., 2 g/m².

The commercial TSSS paint coating, Solarect-Z24®, is manufactured by Color d. d. (SI). The silicone polyester resin binder in a combination of black spinel pigment enables the production of temperature resistant and mechanically durable black TSSS paint coatings on various metals like copper and aluminum characterized by a_{S}=0.90 and e_{T}=0.30, values measured for a copper substrate, which is achieved by a coil-coating or spray application technique.

Production of non-black selective surfaces is highly desirable because of their decorative property. Good examples of their use are façade solar absorbers, passive cooling systems or military applications. Examination of the disclosed properties shows that colored TSSS paint for solar collectors coatings suffer from either too low as but e_{T} values are adequate or e_{T} and as values are acceptable, i.e. having low e_{T} and high a_{S}. In the latter case, the color strength, C* of the coatings do not exceed values of about C*=10, which indicates that the coatings are practically black or gray and thus lack color. Strong colors, C*>15-20, are obtained only for thick coatings, i.e. having thickness of at least 2-4 μm, but such a high thickness inevitably leads to relatively high e_{T} values, e_{T}>0.5. Solar absorptance is also low due to the strong reflection of colors in certain parts of the solar spectrum. The main reason that a high a_{S} and low e_{T} cannot be achieved in combination with high C* values is hiding efficiency of the pigments used is too small, stemming from the imperfect dispersal of the pigments in the organic polymer binder Z. Crnjak Orel, M. Klanj\check{s}ek Gunde, B. Orel, M. Köhl, “Optical properties of black and green selective paints: stability studies of black painted spectrally selective coatings”. In: EuroSun'96 proceedings, A. Goetzberger, J. Luther (Eds.), DGS-Sonnenenergie, Freiburg, Germany, 1996, p. 500-504; Z. Crnjak Orel, B. Orel, A. Len\check{c}ek, M. Hutchins, “Optical properties of black and mixed paint coating in different colour shade on Al substrate”. In: Eurosun 98, Book of Abstracts, (A. Kreiner, R. Perdan, \check{Z}. Kristl (Eds.), International Solar Energy Society—Slovenian Section, Ljubljana, 1998, p. III.1.3.; Z. Crnjak Orel, M. Klanj\check{s}ek Gunde, Solar Energy Mater. Solar Cells, 61 (2000) 445-450.; Z. Crnjak Orel, M. Klanj\check{s}ek Gunde, M. G. Hutchins, Solar Energy Mater. Solar Cells, 85 (2005) 41-50. Moreover, red TSSS paint coatings have not yet been reported.

TISS coatings which can be applied onto metal and non-metal surfaces have been developed over last two decades. Their spectral selectivity has been achieved by adding aluminum pigments and/or other metal and alloy pigments to the coating formulation. Notable publications on the matter have been published by Hoeflaak [M. Hoeflaak: “Optimization of spectrally selective coatings for flat plate solar collectors”, 8th International conference: “Optimising paint formulation: preservation, stabilisation and care”, Amsterdam, November, 1988]. The lowest e_{T} values achieved in the case of black coatings have been e_{T}=0.41, together with the highest solar absorbance of a_{S}=0.90.

The addition of non-black pigments or colored metallic flake pigments to TISS coatings has yielded a series of non-black coatings with either low selectivity or low color strength due to the less than satisfactorily hiding power of the pigments dispersions used B. Orel, H. Spreizer, L. Slemenik Per\check{s}e, M. Fir, A. \check{S}urca Vuka, D. Merlini, M. Vodlan, M. Köhl, “Silicone-based thickness insensitive spectrally selective (TISS) paints as selective paint coatings for coloured solar absorbers” (Part I), Solar Energy Materials & Solar Cells 91, 2007, 93-107 and B. Orel, H. Spreizer, A. \check{S}urca Vuka, D. Merlini, M. Vodlan, M. Köhl, “Selective paint coatings for coloured solar absorbers: Polyurethane thickness insensitive spectrally selective (TISS) paints (Part II)”, Solar Energy Materials & Solar Cells 91, 2007, 108-119. The described coatings are the most suitable for thermal masking of objects and vehicles as camouflage coatings. However, due to the modest spectral selectivity, they are not the best choice TISS coatings for solar absorbers.

The object of the invention is to avoid the deficiencies of the known solutions and to provide production of paints and coatings that show enhanced covering efficiency, enabling the preparation of black or colored Thickness Sensitive Spectrally Selective and Thickness Insensitive Spectrally Selective paint coatings.

### BRIEF DESCRIPTION OF THE DRAWINGS

FIG. 1 is an IR spectra of the bare untreated spinel black pigment (A), coated pigment functionalized with aminosilane (B) and amino silane used as dispersant (C).

FIG. 2 is a SEM image of TSSS paint coating prepared with silane functionalized black spinel pigment, scale 10 μm.

FIG. 3 is a SEM image of TSSS paint coating prepared with black spinel pigment dispersed with Disperbyk 163® (BYK Chemie GmbH), scale 10 μm.

FIG. 4 is a graph of solar absorbance a_{S} as a function of the weight of the paint layer in g/m2 for TSSS paint coatings described in Example 2. For comparison, the same data are given for the commercially available coating Solarect-Z24®, manufactured by Color d. d.

FIG. 5 is a graph of thermal emittance E_{T} as a function of the weight of the paint layer in g/m² for the TSSS paint coatings described in Example 2. For comparison, the same data are given for the commercially available coating Solarect-Z24®, manufactured by Color d. d.

### DETAILED DESCRIPTION OF THE INVENTION

The optical properties of the samples were determined from the measured

IR absorption and reflectance spectra of at least 5×5 cm² sized samples. Reflectance spectra in the visible (VIS) and near-infrared (NIR) range were measured on a Perkin Elmer Lambda 950 UV/Vis/NIR with integration sphere (module 150 mm), while spectra in the middle IR spectral range were obtained on a Bruker IFS 66/S spectrometer equipped with an integrating sphere (OPTOSOL), using a gold plate as a standard for diffuse reflectance. The solar absorbance (a_{S}) and thermal emittance (e_{T}) values for bare Sunselect MTMS-protected Sunselect were calculated according to a standard procedure: M. Kohl, G. Jorgensen, A. W. Czanderna, Performance and Durability Assessment: Optical Materials for Solar Thermal Systems, Elsevier, The Netherlands, 2004 and M. G. Hutchins, Spectrally selective materials for efficient visible, solar and thermal radiation control, in: M. Santamouris (Ed.), Solar Thermal Technologies for Buildings, James & James, London, 2003. C* values were determined from reflectance spectra (recorded on previous mentioned machines) according to CIE Technical report: Colorimetry 3^{rd} ed. 2004, The International Commission on Illumination, Wien, p. 17 (ISBN 3 901 906 33 9).

The core of this invention is the functionalization of the inorganic pigment with aminosilane, performed by dispersing the pigment in a solution of aminosilane in solvent or various solvent mixtures together with the organic polymer binder, followed by the milling of pigment/aminosilane/solvent/binder dispersion. This process leads to firm and irreversible bonding of the silanes onto the pigment surface. Dispersions/pigment pastes made of functionalized pigments enable the preparation of various paints appropriate for various applications, as described in the examples below and the patent claims.

The pigments intended to be functionalized are of, but are not limited to, spinel and oxides of titanium, chromium, iron, zinc and the corresponding mixed oxides and oxyhydroxydes.

Solvents are preferably, but not limited to, aliphatic, cycloaliphatic, aromatic and heteroaromatic compounds, alcohol, ester, ether type or mixtures thereof.

The binders are preferably, but not limited to, silicone or substituted silicones, polyurethanes and fluoro co-polymers or a mixture of corresponding binders.

The key compounds of this invention are various aminosilanes described by the formula

$$Si {\sum }_{nm} {R}_{n} \sum {R}_{m} ,$$

where n+m=4 and Rₙ represents an un-substituted or substituted alkyloxy or cycloalkyloxy group of C₁ to C₇ or an un-substituted or substituted aryloxy or hetereroaryloxy 5-7 member ring group or chloro substituent, Rₘ represents an amino or polyamino substituted alkyl or cykloalkyl group of C₁ to C₁₈ or amino substituted aryl or hetereroaryl 5-7 member ring. In addition, the aminosilane could be an oligomere of such a compound.

Additives are compounds or mixtures of them added to paint formulations in an amount of 10% or less of the total formulation, which serve to improve the dispersion process, the application of the dispersed pigments and the adjustment of specific properties of the paints and the ensuing coatings such as, but not limited to, their rheological, surface and adhesion properties. The term additive does not comprise dispersal agents.

The procedure for inorganic pigment functionalization with aminosilanes consists of dispersing the pigment in a solution of 0.05-30% of the aminosilane by weight of the pigment, in a solvent or solvent binder mixture for 5 minutes to 6 hours. Dispersal may be followed by grinding of the said dispersion to the desired fineness. In order to improve the efficiency of dispersal and or milling the pigments, a suitable amount of binder and/or standard additives may be included in the formulations.

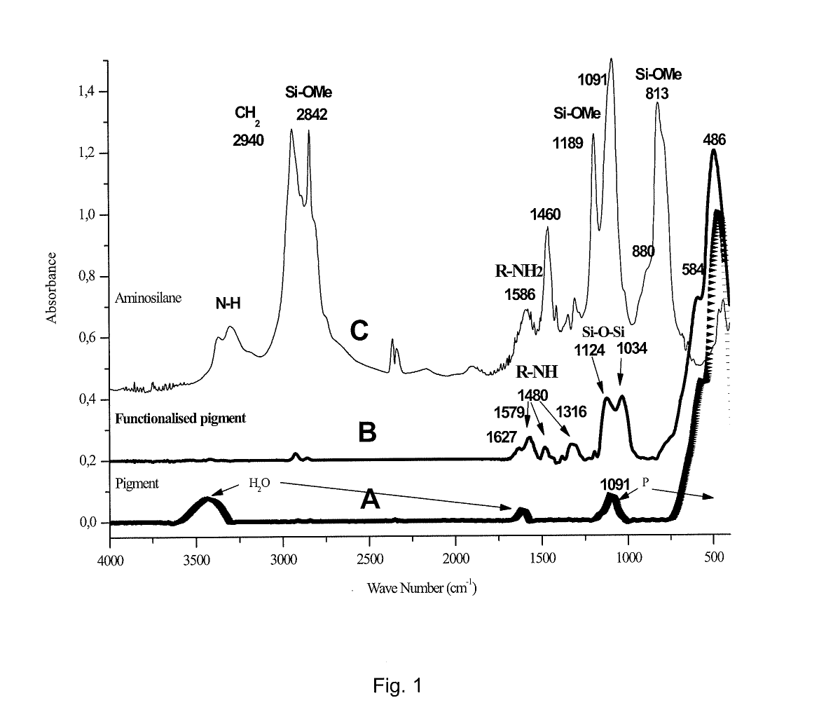

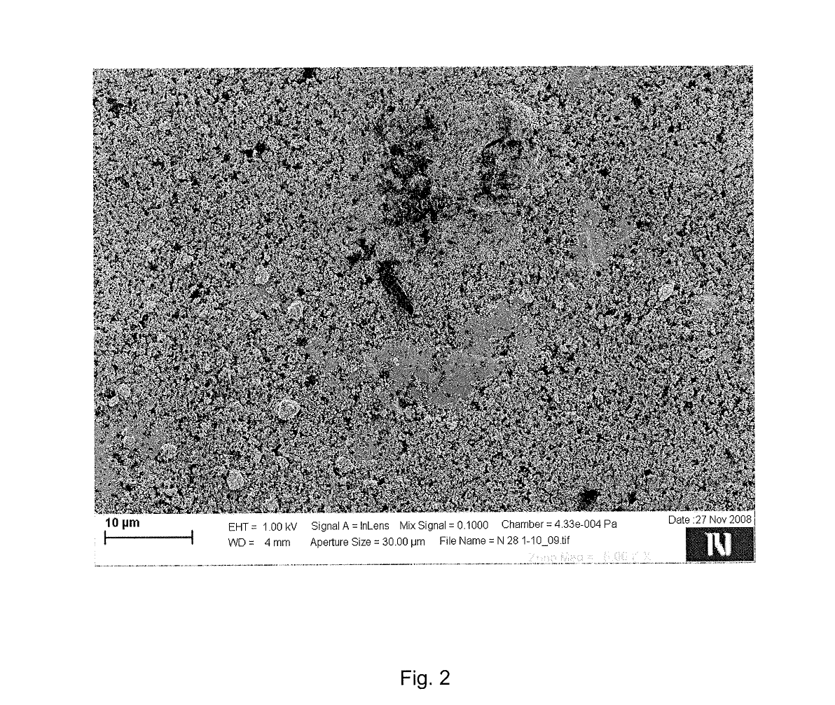

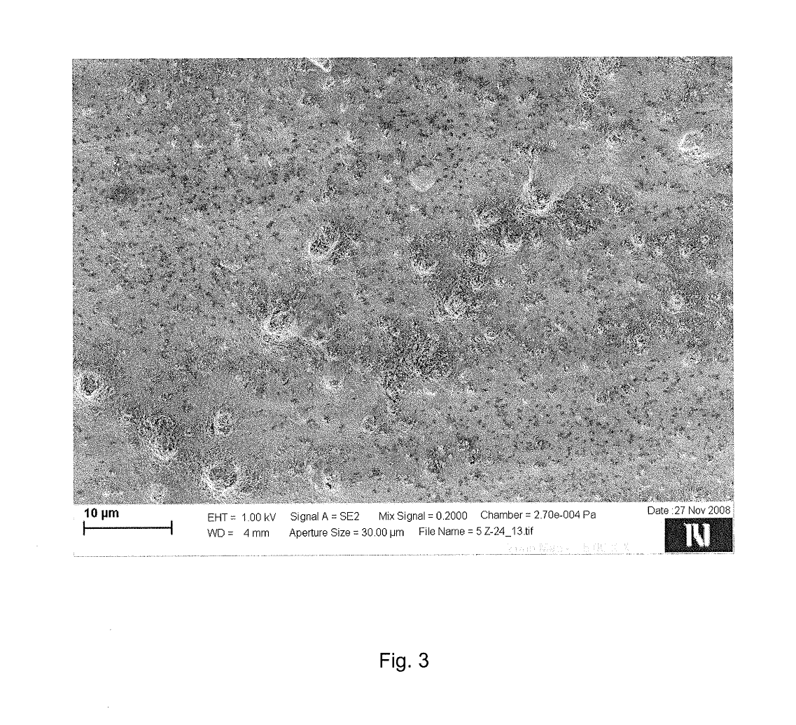

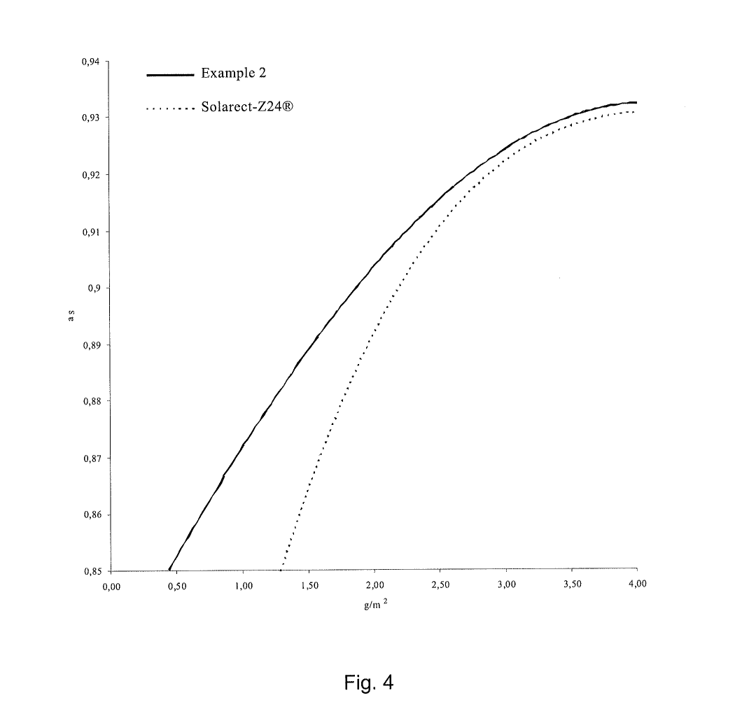

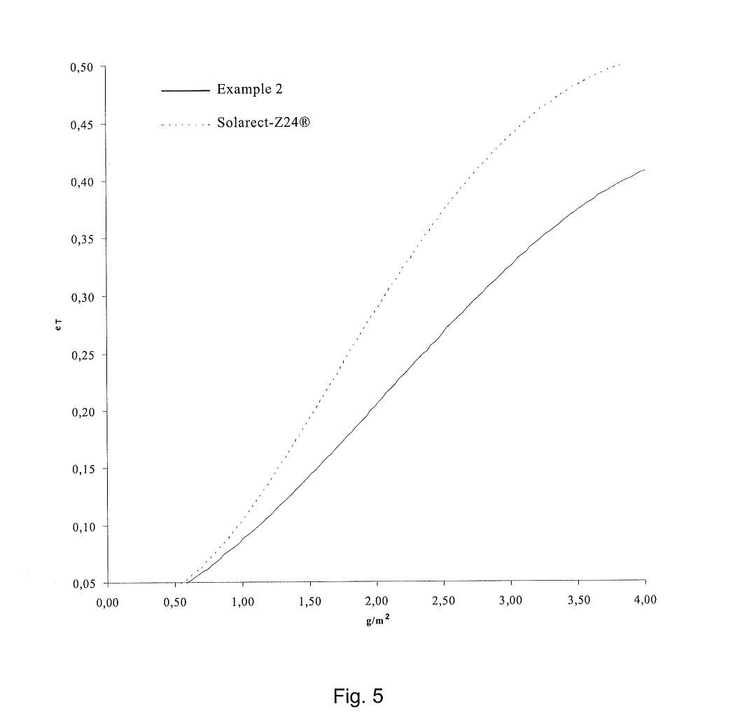

The functionalization of an inorganic pigment by aminosilanes is demonstrated by three interrelated but independent sets of results: (i) infrared spectra of functionalized pigments (FIG. 1), (ii) the state of dispersions obtained after the application of aminosilane dispersants (FIGS. 2 and 3) and (iii) the optical properties of the paint coatings (FIGS. 4 and 5) prepared from the corresponding pigment dispersions.

(i) The first experiment undoubtedly proves that the aminosilanes bond onto the surface of the pigment particle during the dispersal and subsequent milling of the pigment in the aminosilane-solvent-resin binder solution.

FIG. 1 shows the IR spectra of the bare 24-3060 PK pigment (Ferro GmbH) (A), pigment functionalized with aminosilane (B) and aminosilane (C). For example, in the spectrum of the bare pigment, in addition to the bands attributed to the pigment indicated by P weak bands of the water were seen due to the moisture present in untreated commercial pigment. The presence of moisture is important, since it triggers hydrolysis of the aminosilane which leads to the formation of the silanol groups required for achieving condensation of the aminosilane directly onto the surface of the pigment.

The functionalized pigment was taken out of the reaction mixture and immediately thoroughly rinsed with solvent in order to remove all the non-bonded species from its surface, then the IR spectra (FIG. 1 at B) was recorded. In the IR spectra, the characteristic absorption bands of the amino groups, marked R—NH, were recognized, together with bands attributed to the siloxane groups, marked Si—O—Si. The frequencies of the R—NH and the Si—O—Si bands shifted and changed their intensities, clearly demonstrating the condensation of the hydrolyzed aminosilane and its bonding to the pigment surface. Because the IR spectra of the surface functionalized pigment (FIG. 1 at B) showed bands of the condensation products of the hydrolysis-condensation reactions of the aminosilane (FIG. 1 at C), it was impossible to rule out the possibility of self-condensation of aminosilane molecules. However, self-condensed aminosilane species did not detrimentally impact on the effectiveness of the pigment particles' functionalization, but merely indicated that a thicker aminosilane layer formed during the bonding and dispersal process. Accordingly, the IR spectra proved the formation of a pigment wrapped by variously interlinked aminosilane moieties via the Si—O—Si bonds, thus excluding the existence of two separated and non-interacting pigment and aminosilane phases.

(ii) The second experiment shows the difference in morphology of dispersions of aminosilane functionalized and non-functionalized pigments.

Two pigment dispersions with the same PVC ratios were made by dispersion, and subsequently ground to the same fineness <1 μm, measured according to ISO 1524. Both dispersions were applied in the form of thin layer onto the metal substrate and allowed to dry and cure to harden. Comparison of the corresponding SEM micrographs (FIGS. 2 and 3) shows that the pigment particles are more evenly distributed in the dispersion prepared with the aminosilane-functionalized pigment, which can be inferred from the even distribution and smaller size of the pigment particles, while the SEM micrographs of the paint dispersions made of non-functionalized pigment showed lumps and regions in which the pigment particles were agglomerated and their distribution was not uniform.

(iii) This experiment provided the final and the most convincing proof of the effective modification of the pigments' surface by aminosilane dispersants. Two different TSSS paint coatings were applied onto a copper substrate by spraying in order to make TSSS coatings with various thicknesses. The first, called Example 2, was based on the aminosilane functionalized pigment corresponding to the paint described in Example 2, while the second one, called Solarect Z-24®, corresponded to commercial Solarect Z-24® TSSS paint coatings manufactured by Color d. d. (SI). The thickness of the deposited TSSS paint coatings was controlled by altering the amount of solvent added to the prepared paints and was expressed by the weight of dry paint per m². The paints were first dried and then temperature cured and their a_{S} and e_{T} values were then determined from the measured hemispherical IR reflection spectra. The results shown in FIGS. 4 and 5 reveal that the coatings made of the paint (Example 2) with the functionalized pigments exhibited higher solar absorbance and lower thermal emittance values than the Solarect Z-24® paint coatings with the same physical thickness. Higher solar absorbance values indirectly proved that the covering efficiency of the paints made from the aminosilane treated pigment dispersions was higher than those made of the commercial Solarect Z-24® coatings (FIG. 5). The beneficial effect of functionalized pigment can also be understood from FIG. 4, which shows the variation of thermal emittance values of the commercial Solarect Z-24® and Example 2 coatings as a function of the coating thickness expressed in grams of dry paint film per m². The thermal emittance of the coatings made of functionalized pigment dispersion clearly exhibited lower e_{T} values than the thermal emittance of the commercial Solarect Z-24® paint coatings. The beneficial effect of the aminosilane treatment on thermal emittance values was more pronounced, up to 10%, than on solar absorbance values, 1-3%, when the same coating thicknesses were considered. To conclude, the results showed that the use of aminosilane for the paint preparation resulted in increased solar absorbance and simultaneous reduction of the thermal emittance of the coatings. In other words, the former TSSS coatings exhibited higher spectral selectivity.

The preparation of the aminosilane-functionalized pigments and dispersions.

Aminosilane functionalized pigments can be isolated after functionalization by filtering the dispersion, washing it with solvents and then drying the washed pigment. Other separation methods, subject to practicability or their availability, can also be used.

Pigment pastes could be prepared from aminosilane functionalized pigments in much the same way as pastes made of other non-functionalized pigments: functionalization can be performed, preferably at the earliest possible stage, in the production of the pastes or an isolated functionalized pigment can be used.

For functionalized pigment paints, pigments can be functionalized in-situ during preparation of the paint. It is recommended that pigment functionalization be performed at the earliest possible stage in the production process. Alternatively, functionalized pigment paste or an isolated functionalized pigment can be used.

In general, the preparation procedure for functionalized pigment dispersions followed common procedures used in the paint industry.

The application and usage of aminosilane functionalized pigments for making paints: TSSS and TISS spectrally selective coatings.

Due to their enhanced covering efficiency and the ability to form stable pigment dispersions with much higher pigment loadings than ordinary paints, aminosilane-functionalized pigments are suitable for the manufacture of any paint coatings in which high pigment loadings combined with excellent mechanical stability and specific optical effects, such as high solar absorbance and low thermal emittance are desired. TSSS and TISS paint coatings for solar absorbers are typical examples of their application.

Black TSSS paint coatings for solar absorbers with spectral selectivity as high as a_{S}=0.91, e_{T}=0.06 and good adhesion and thermal stability can be made by using aminosilane functionalized pigments. Colored, i.e., non-black or gray, TSSS coatings for solar absorbers, where their aesthetic appearance is important, with spectral selectivity as high as a_{S}=0.85, e_{T}=0.18 and color strength of C*=18, retaining good adhesion and thermal stability, can be made by using aminosilane functionalized pigments. All the aforementioned TSSS paint coatings should have a solid matter content, i.e., aminosilane functionalized pigment, of 30-75%, 25-70% of binder, 0-40% of other pigments, 0-30% fillers and 0-10% additives.

TSSS paints can be applied to a metal or a metalized surface by spraying, coil-coating or dipcoating.

Black and gray TISS coatings for solar absorbers suitable for solar collector systems with spectral selectivity as high as a_{S}=0.91 and e_{T}=0.35, and colored, i.e., non-black or gray, TISS paint coatings for solar absorbers with spectral selectivity as high as a_{S}=0.84, e_{T}=0.40 and color strength ranging from C*=10 up to C*=20, can be made by using aminosilane modified pigment dispersions. Regardless their color, TSSS and TISS paint coatings offer excellent coatings, showing good adhesion, thermal and UV stability and excellent corrosion resistance and moderate abrasion resistance. TISS coatings should have a solid matter content of 5-70% aminosilane functionalized pigment, 10-50% metal flakes of either natural look or colored, 0-40% other pigments, 0-30% fillers, 25-70% binder and 0-10% additives.

Aminosilane functionalized pigments offer an excellent choice for thermovision camouflage paints for military applications for moving or stationary objects and are characterized by a broad frequency response from 0.3 up to 50 μm and the ability to provide camouflage in the form of a single coat of the paint. Their shade can be adjusted in terms of the need to make an object with low observance in various environments like marine, earth, snow, deserts, forests, with the ability to reduce the radiative temperature by at least 50%. They offer good adhesion, thermal and UV stability and excellent corrosion resistance, and adequate abrasion resistance for this application. Their optical properties in the VIS, NIR and thermal IR parts of the electromagnetic spectrum ensure good blending with the surroundings. Their typical composition is similar to those used for colored TISS paint coatings: 5-70 aminosilane functionalized pigment, 10-50% metal flakes of either natural look or colored, 0-40% other pigments, 0-30% fillers, 25-70% binder and 0-10% additives.

TISS paints can be applied to a metal or a non-metal surface by spraying, coil-coating or dipcoating.

Aminosilane functionalized pigments, such as titanium dioxide or zinc oxide, are suitable for making solar cool paints and as micro-fillers for transparent lacquers and bulk commodity plastics. The invention is additionally explained by the following examples, which are in no way limiting.

### Example 1

### General Procedure for a 45% Pigment Paste Made of Aminosilane Functionalized Pigment and Silicone-Polyester Binder

| | | |
|---|---|---|
| Silikoftal ® Non-stick 60 (Evonik Tego Chemie GmbH) | 170 | g |
| An inorganic pigment | 450 | g |
| Bentone ® SD-2 (Elementis Specialties, Inc.) | 10 | g |
| [3-(2-aminoethyl)aminopropyl]trimetoxysilane | 25 | g |
| Xylene | 230 | g |
| n-butylacetate | 115 | g |

An inorganic pigment is gradually added to a solution of [3-(2-aminoethyl)aminopropyl]trimethoxysilane in xylene under continuous dispersion. When the addition has been completed, dispersion is continued for a further 15 minutes, then 150 g Silikoftal® Non-stick 60 is added under constant dispersion, followed by Bentone® SD-2 and dispersion continued for a further 15 minutes. The obtained dispersion is milled in a sand mill at approximately ˜3000 RPM to a particle size <1 μm (ISO 1524). N-butylacetate is added under constant dispersion.

### Example 2

### Black Silicone-Polyester TSSS Coating Prepared from an Aminosilane Functionalized Pigment Paste

| | | |
|---|---|---|
| 45% black aminosilane functionalized pigment paste | 890 | g |
| made according to Example 1 with 24-3060 PK pigment | | |
| (Ferro GmbH) | | |
| Silikoftal ® Non-stick 60 (Evonik Tego Chemie GmbH) | 110 | g |

Silikoftal® Non-stick 60 is added under constant dispersion to a 45 black aminosilane functionalized pigment paste made according to Example 1 with 24-3060 PK pigment (Ferro GmbH).

A coating prepared in such a way, suitably diluted, can be applied by coil-coating or spray coating methods. The deposited coating is hardened by heating at 200-250° C. for 10-20 min, or for a longer time at lower temperatures, if the substrate requires such a reduction of the curing temperature.

By spraying the paint onto a copper substrate, the prepared coating with an equivalent thickness of 1 g/m² has adhesion of Gt0 (ISO 2409), and its spectral selectivity is denoted by a_{S}=0.91 and e_{T}=0.06.

### Example 3

### Black 2-Component Polyurethane TSSS Coating

| | | |
|---|---|---|
| Desmophen ® A 365 (Bayer MaterialScience AG) | 240 | g |
| 24-3060 PK (Ferro GmbH) | 381 | g |
| Bentone ® SD-2 (Elementis Specialties, Inc.) | 13 | g |
| 3-aminopropyltrimethoxysilane | 13 | g |
| Xylene | 168 | g |
| n-butylacetate | 91 | g |
| BYK ® 410 (BYK-Chemie GmbH) | 3 | g |
| Desmodur ® N 75 (Bayer MaterialScience AG) | 91 | g |

Component A is prepared by gradually adding black pigment 24-3060 PK to a solution of 3-aminopropyltrimethoxysilane in xylene under continuous dispersion. After adding has been completed, mixing continues for a further 15 minutes, then 150 g Desmophen® A 365 is also added under constant dispersion, followed by Bentone® SD-2 and dispersion continued for a further 15 minutes. The obtained dispersion is milled in a sand mill at approximately 3000 RPM to a particle size <1 μm (ISO 1524). While continuously dispersing, a further 90 g Desmophen® A 365, butylacetate and BYK® 410 are added to the paste.

Prior to use, component A of the coating prepared in such a way is mixed with component B, Desmodur® N 75.

A coating prepared in such a way, suitably diluted, can be applied by coil-coating or spray coating methods.

By spraying the paint onto a copper substrate, the prepared coating with an equivalent thickness of 1 g/m2 has adhesion of Gt0 (ISO 2409), and its spectral selectivity is denoted by a_{S}=0.92 in e_{T}=0.18.

### Example 4

### Black Silicone-Polyester TISS Coating Prepared from an Aminosilane Functionalized Pigment Paste

| | | |
|---|---|---|
| 45% black aminosilane functionalized pigment paste | 327 | g |
| made according to Example 1 with 24-3060 PK pigment | | |
| (Ferro GmbH) | | |
| Alubright 3100 (Schlenk Metallic Pigments GmbH) | 274 | g |
| BYK ® 410 (BYK-Chemie GmbH) | 10 | g |
| 4-hydroxy-4-methylpentan-2-one | 12 | g |
| Silikoftal ® Non-stick 60 (Evonik Tego Chemie GmbH) | 245 | g |
| n-butylacetate | 50 | g |
| Solvesso ® 100 (Exxon Mobil Corporation) | 50 | g |
| Additol ® XL 186 (Cytec Industries inc.) | 32 | g |

The 45% black aminosilane functionalized pigment paste made according to Example 1 with 24-3060 PK pigment (Ferro GmbH) is slowly worked into Alubright 3100 and Silikoftal® Non-stick 60, 4-hydroxy-4-methylpentan-2-one, n-butylacetate, Solvesso® 100, Additol® XL 186 and BYK® 410 are added under constant dispersion.

A coating prepared in such a way, suitably diluted, can be applied by the coil-coating or spray coating methods.

When properly applied by the spray coating method, a coating prepared in such a way with a thickness of 30 to 100, mm has adhesion of Gt0 (ISO 2409) and its spectral selectivity is denoted by a_{S}=0.90 in e_{T}=0.35.

### Example 5

### Brick Red Silicone-Polyester TSSS Coating Prepared from Aminosilane Functionalized Pigment Pastes

| | | |
|---|---|---|
| 45% red aminosilane functionalized pigment paste made | 855 | g |
| according to Example 1 with Bayferrox 130M pigment | | |
| (LANXESS Deutschland GmbH) | | |
| 45% black aminosilane functionalized pigment paste | 95 | g |
| made according to Example 1 with 24-3060 PK pigment | | |
| (Ferro GmbH) | | |
| Silikoftal ® Non-stick 60 (Evonik Tego Chemie GmbH) | 50 | g |

The 45% black aminosilane functionalized pigment paste made according to Example 1 with 24-3060 PK pigment (Ferro GmbH) and Silikoftal® Non-stick 60 is added under constant dispersion to 45% red aminosilane functionalized pigment paste made according to Example 1 with Bayferrox 130M pigment (LANXESS Deutschland GmbH).

A coating prepared in such a way, suitably diluted, can be applied by the coil-coating or spray coating methods. The deposit is hardened by heating at 200-250° C. for 10-20 min, or longer at lower temperatures if the substrate requires such a reduction.

A coating prepared in such a way, properly sprayed onto a copper substrate with a gramature (thickness) of 2 g/m2, has adhesion of Gt0 (ISO 2409), its spectral selectivity is denoted by a_{S}=0.85 and e_{T}=0.18 and its color strength is denoted by C*=18.

### Example 6

### Blue Silicone-Polyester TISS Coating Prepared from an Aminosilane Functionalized Pigment Paste and Colored Metal Pigment

| | | |
|---|---|---|
| 45% black aminosilane functionalized pigment paste | 58 | g |
| made according to Example 1 with 24-3060 PK pigment | | |
| (Ferro GmbH) | | |
| Standart ® Alucolor Blau 1504 (Eckart GmbH & Co. KG) | 232 | g |
| BYK ® 410 (BYK-Chemie GmbH) | 4 | g |
| 4-hydroxy-4-methylpentan-2-one | 8 | g |
| Silikoftal ® Non-stick 60 (Evonik Tego Chemie GmbH) | 234 | g |
| Methoxypropylacetate | 174 | g |
| Solvesso ® 100 (Exxon Mobil Corporation) | 174 | g |
| Color Uni pasta Violet RL (Color d.d.) | 116 | g |

The 45% black aminosilane functionalized pigment paste made according to Example 1 with 24-3060 PK pigment (Ferro GmbH) is slowly worked into Standart® Alucolor Blau 1504 (Eckart GmbH & Co. KG) and, under constant dispersion, Silikoftal® Non-stick 60, 4-hydroxy-4-methylpentan-2-one, n-butylacetate, Solvesso® 100, Additol® XL 186 and BYK® 410 are added.

A coating prepared in such a way, suitably diluted, can be applied by coil-coating or spray coating methods.

When properly applied by the spray coating method, a coating prepared in such a way with a thickness of 30 to 100 mm has adhesion of Gt0 (ISO 2409), its spectral selectivity is denoted by a_{S}=0.87 in e_{T}=0.43 and its color strength is denoted by C*=17.

### Example 7

### Olive Green Silicone-Polyester TISS Coating Prepared from an Aminosilane Functionalized Pigment Pastes

| | | |
|---|---|---|
| 45% green aminosilane functionalized pigment paste made | 216 | g |
| according to Example 1 with GN-M pigment | | |
| (LANXESS Deutschland GmbH) | | |
| 45% yellow aminosilane functionalized pigment paste | 110 | g |
| made according to Example 1 with Bayferrox 3920 | | |
| pigment (LANXESS Deutschland GmbH) | | |
| 45% black aminosilane functionalized pigment paste made | 80 | g |
| according to Example 1 with 24-3060 PK pigment | | |
| (Ferro GmbH) | | |
| Alubright 3100 (Schlenk Metallic Pigments GmbH) | 310 | g |
| BYK ® 410 (BYK-Chemie GmbH) | 10 | g |
| 4-hydroxy-4-methylpentan-2-one | 12 | g |
| Silikoftal ® Non-stick 60 (Evonik Tego Chemie GmbH) | 150 | g |
| n-butylacetate | 40 | g |
| Solvesso ® 100 (Exxon Mobil Corporation) | 40 | g |
| Additol ® XL 186 (Cytec Industries inc.) | 328 | g |

All three 45% aminosilane functionalized pigment pastes made according to Example 1 are slowly worked into Alubright 3100 and, under constant dispersion, Silikoftal® Non-stick 60, 4-hydroxy-4-methylpentan-2-one, n-butylacetate, Solvesso® 100, Additol® XL 186 and BYK® 410 are added.

A coating prepared in such a way, suitably diluted, can be applied by coil-coating or spray coating methods.

When properly applied by the spray coating method, a coating prepared in such a way with a thickness of 30 to 100 mm has adhesion of Gt0 (ISO 2409), its spectral selectivity is denoted by a_{S}=0.83 in e_{T}=0.42 and its color strength is denoted by C*=13.

What is claimed is:

1. A method of manufacturing a TSSS coating for use on copper or aluminum applied by coil-coating, the method comprising the steps of:
providing an inorganic pigment;
providing a solvent;
providing a binder;
providing an aminosilane;
functionalizing the inorganic pigment with the aminosilane by dispersing the inorganic pigment without adding a non-aminosilane dispersing agent in a solution of the aminosilane in the solvent, or in a solution of the aminosilane in a mixture of the solvent and the binder, including at least one of the following three modifications:
in-situ dispersion during coating,
dispersion during production of a pigment paste, and
dispersion with a subsequent isolation of the aminosilane functionalized pigment; and
forming the TSSS coating with a solid matter content of:
30-75% of the inorganic pigment functionalized by the aminosilane,
25-70% of the binder,
0-40% of other pigments,
0-30% of fillers,
0-10% of additives.

2. The method according to claim 1, wherein the additives include a rheological additive.

3. The method according to claim 1, wherein the solution contains 0.05-30% of aminosilane and functionalization of the inorganic pigment includes a subsequent step of grinding the inorganic pigment.

4. The method according to claim 1, wherein the solvent comprises an aromatic, aliphatic, cycloaliphatic, ketone, ester, ether or alcohol compound, or a mixture thereof.

5. The method according to claim 1, wherein the binder comprises a silicone-polyester, polyurethane, or fluoropolymer binder.

6. The method according to claim 1, wherein the method produces a pigment paste.

7. The method according to claim 1, further comprising by the coating having a spectral selectivity of a_{S}≧0.90 solar absorbance, and by a thermal emittance of e_{T}≦0.20.

8. The method according to claim 1, wherein the coating is a coil-coating applied by rollers.

9. The method according to claim 1, wherein the coating is a coil-coating applied by one or more slot dies.

10. The method according to claim 1, wherein the coating is applied to a coil of copper or aluminum.

11. A method of manufacturing a TISS coating for use on copper or aluminum applied by coil-coating, the method comprising the steps of:
providing an inorganic pigment;
providing a solvent;
providing a binder;
providing an aminosilane;
functionalizing the inorganic pigment with the aminosilane by dispersing the inorganic pigment without adding a non-aminosilane dispersing agent in a solution of the aminosilane in the solvent, or in a solution of the aminosilane in a mixture of the solvent and the binder, including at least one of the following three modifications:
in-situ dispersion during coating,
dispersion during production of a pigment paste, and
dispersion with a subsequent isolation of the aminosilane functionalized pigment; and
forming the TISS coating with a solid matter content of:
5-70% of the inorganic pigment functionalized by the aminosilane,
10-50% of metal flakes in an amount,
0-40% of other pigments,
25%-70% of the binder,
0-30% of fillers,
0-10% of additives.

12. The method according to claim 11, wherein the solution contains 0.05-30% of aminosilane and functionalization of the inorganic pigment includes a subsequent step of grinding the inorganic pigment.

13. The method according to claim 11, wherein the solvent is an aromatic, aliphatic, cycloaliphatic, ketone, ester, ether or alcohol compound, or a mixture thereof.

14. The method according to claim 11, wherein the binder is a silicone-polyester, polyurethane, or fluoropolymer as the binder.

15. The method according to claim 11, wherein the method produces a pigment paste

16. The method according to claim 15, wherein the additives include a rheological additive.

17. The method according to claim 11, wherein the metal flakes are coated metal flakes.

18. The method according to claim 11, further comprising the step of adding a silicon-polyester polymer.

19. The method according to claim 11, wherein the binder is a polyurethane or a fluoropolymer.

20. The method according to claim 11, wherein the TISS coating has a spectral selectivity of a_{S}≧0.90 solar absorbance and by a thermal emittance of e_{T}≧0.20.
